(19) United States
(12) Patent Application Publication
(10) Pub. No.: US 2023/0330866 A1
(43) Pub. Date: Oct. 19, 2023

(54) INFORMATION PROCESSING APPARATUS, INFORMATION PROCESSING METHOD, AND INFORMATION PROCESSING PROGRAM

(71) Applicant: SONY GROUP CORPORATION, TOKYO (JP)

(72) Inventors: TAKARA KASAI, TOKYO (JP); TOSHIMITSU TSUBOI, TOKYO (JP); SATOKO NAGAKARI, TOKYO (JP); HIROYUKI SUZUKI, TOKYO (JP); TAKUYA KOMAMI, TOKYO (JP); TOMOHARU HARAGUCHI, TOKYO (JP); ATSUSHI SAKAMOTO, TOKYO (JP)

(21) Appl. No.: 18/043,448

(22) PCT Filed: Aug. 27, 2021
(86) PCT No.: PCT/JP2021/031527

§ 371 Date: Feb. 28, 2023

(30) Foreign Application Priority Data
Sep. 10, 2020 (JP) 2020-152352

(51) Int. Cl. B25J 13/08; B25J 15/12

(52) U.S. Cl. CPC B25J 13/081; B25J 15/12

(57) ABSTRACT

An information processing apparatus (30) includes: an operation control unit (321) that operates at least one of a first finger and a second finger to change contact positions with a target object in a state where the first finger and the second finger grip the target object; and an estimation unit (322) that estimates a shape of the target object on a basis of a relationship between the contact positions and postures of the first finger and the second finger.

### FIELD

The present disclosure relates to an information processing apparatus, an information processing method, and an information processing program.

### BACKGROUND

In the related art, research for causing a robot to perform work that has been performed by a person is in progress. Patent Literature 1 discloses a measurement system capable of measuring a characteristic of a measurement target object on the basis of information on a pressure distribution between the measurement target object and a pressing unit.

### CITATION LIST

### Patent Literature

Patent Literature 1: JP 2006-47145 A

### SUMMARY

### Technical Problem

For example, it is assumed that a manipulator is used for housework support or care/assistance, and it is desired to grip objects of various shapes.

Therefore, the present disclosure proposes an information processing apparatus, an information processing method, and an information processing program capable of easily estimating shapes of various target objects to be gripped.

### Solution to Problem

To solve the problems described above, an information processing apparatus according to an embodiment of the present disclosure includes: an operation control unit that operates at least one of a first finger and a second finger to change contact positions with a target object in a state where the first finger and the second finger grip the target object; and an estimation unit that estimates a shape of the target object on a basis of a relationship between the contact positions and postures of the first finger and the second finger.

Moreover, an information processing method according to an embodiment of the present disclosure includes: operating, by a computer, at least one of a first finger and a second finger to change contact positions with a target object in a state where the first finger and the second finger grip the target object; and estimating, by the computer, a shape of the target object on a basis of a relationship between the contact positions and postures of the first finger and the second finger.

Moreover, an information processing program according to an embodiment of the present disclosure causes a computer to execute: operating at least one of a first finger and a second finger to change contact positions with a target object in a state where the first finger and the second finger grip the target object; and estimating a shape of the target object on a basis of a relationship between the contact positions and postures of the first finger and the second finger.

### BRIEF DESCRIPTION OF DRAWINGS

FIG. 1 is a diagram for explaining an example of a robot including an information processing apparatus according to an embodiment.

FIG. 2 is a view illustrating an example of a configuration of a hand of the robot according to the embodiment.

FIG. 3 is a view for explaining an example of an operation of the hand illustrated in FIG. 2.

FIG. 4 is a diagram illustrating a configuration example of the robot according to the embodiment.

FIG. 5 is a flowchart illustrating a processing procedure executed by the information processing apparatus according to the embodiment.

FIG. 6A is a diagram for explaining a relationship among a thumb, an index finger, and a pressure distribution under control of the information processing apparatus according to the embodiment.

FIG. 6B is a diagram for explaining a relationship among the thumb, the index finger, and the pressure distribution under control of the information processing apparatus according to the embodiment.

FIG. 6C is a diagram for explaining the relationship among the thumb, the index finger, and the pressure distribution under the control of the information processing apparatus according to the embodiment.

FIG. 6D is a diagram for explaining the relationship among the thumb, the index finger, and the pressure distribution under the control of the information processing apparatus according to the embodiment.

FIG. 7 is a diagram for explaining a relationship among the thumb, the index finger, and the pressure distribution under the control of the information processing apparatus according to the embodiment.

FIG. 8 is a diagram for explaining a relationship between the thumb, the index finger, and the pressure distribution under the control of the information processing apparatus according to the embodiment.

FIG. 9 is a flowchart illustrating a processing procedure executed by an information processing apparatus according to a modification (1) of the embodiment.

FIG. 10 is a view illustrating an example of a configuration of a hand according to a modification (2) of the embodiment.

FIG. 11 is a diagram for explaining an example of information processing of an information processing apparatus according to a modification (3) of the embodiment.

FIG. 12 is a hardware configuration diagram illustrating an example of a computer that implements functions of an information processing apparatus.

### DESCRIPTION OF EMBODIMENTS

Hereinafter, embodiments of the present disclosure will be described in detail with reference to the drawings. Note that, in each of the following embodiments, the same parts are denoted by the same reference numerals, and redundant description will be omitted.

In a case where a robot such as a mobile manipulator is used for housework support or care/assistance support, a scene where a liquid in a pot is poured into another container can be cited as an assumed use case. In order to do this, it is necessary to pour liquid to the extent that it does not overflow, but it is necessary to recognize how much amount can be poured into the container to be poured.

For example, in an environment where the shape of the container to be handled can be specified in advance, the robot can estimate the accurate volume of the container. On the other hand, in an environment where the container shape cannot be specified in advance, the robot needs to observe and recognize the amount that can be poured by some method in a timely manner. For example, a method of recognizing a volume by measuring a detailed shape of a container, a method of preventing overflow by pouring while observing a liquid level or a liquid level, and the like can be considered. The method of recognizing the volume is required to correctly recognize the shape of the container even if the side surface of the container has a tapered shape or a smooth curved surface. In addition, in the method of preventing overflow by pouring while observing the liquid level or the liquid level, a configuration for observing the liquid level or the liquid level is required, and the cost of the robot increases. Therefore, the present disclosure provides a technique capable of estimating the shape of the target object with a simple configuration.

### EMBODIMENT

### Outline of Robot According to Embodiment

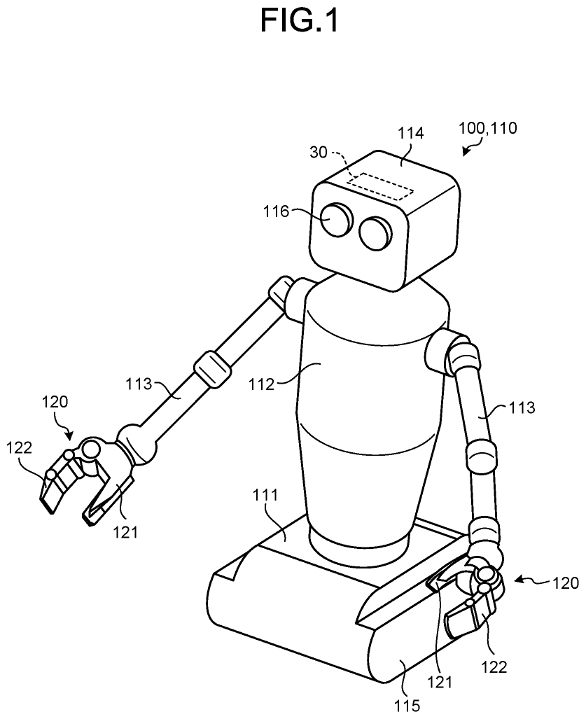

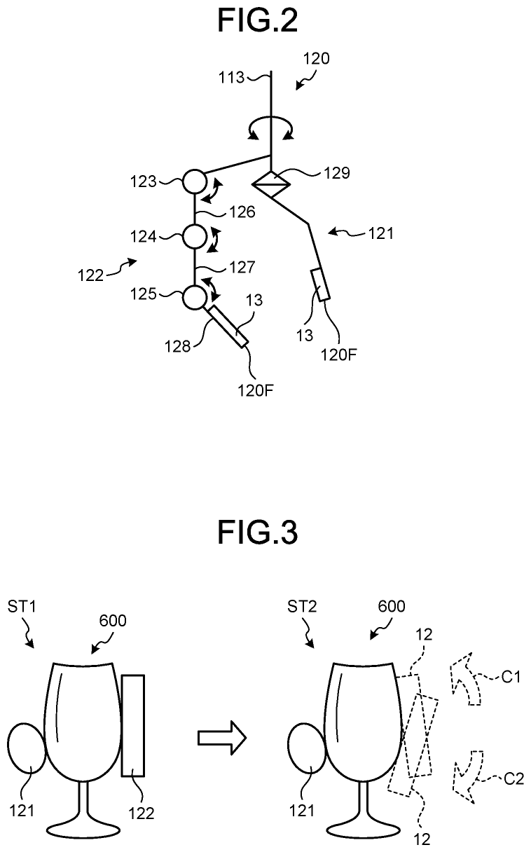

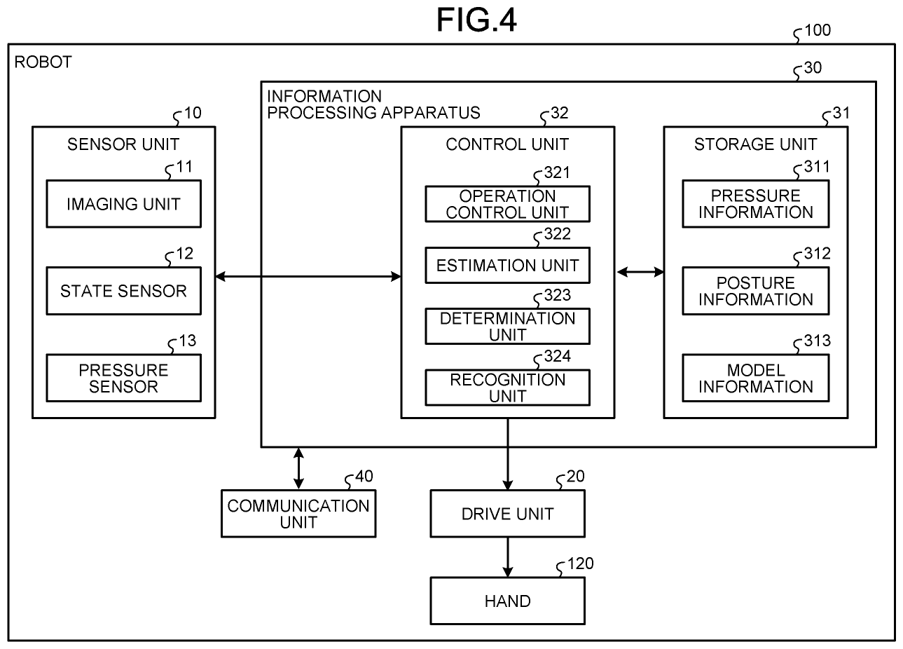

FIG. 1 is a diagram for explaining an example of a robot including an information processing apparatus according to an embodiment. FIG. 2 is a view illustrating an example of a configuration of a hand of the robot according to the embodiment. FIG. 3 is a view for explaining an example of an operation of the hand illustrated in FIG. 2.

As illustrated in FIG. 1, a robot 100 is, for example, a dual arm robot imitating a humanoid. The robot 100 includes a main body 110. The main body 110 includes a base portion 111 as a base, a body portion 112 supported on the base portion 111, an arm 113 provided on the body portion 112, a head portion 114 provided on an upper portion of the body portion 112, and a moving mechanism 115 provided on a lower side of the base portion 111.

The head portion 114 is provided with an imaging unit 11 that images the front of the main body 110. Hereinafter, in the main body 110, a surface on which the imaging unit 11 is provided is referred to as a front surface, a surface facing the surface on which the imaging unit 11 is provided is referred to as a rear surface, and a surface sandwiched between the front surface and the rear surface and in a direction other than the vertical direction is referred to as a side surface. An optical camera or the like can be exemplified as the imaging unit 11. The imaging unit 11 can be used for sensing a target object to be gripped by a hand 120 of the arm 113.

The arm 113 is provided in the body portion 112. The number of arms 113 is arbitrary. In the illustrated example, two arms 113 are provided symmetrically on two opposing side surfaces of the body portion 112. The arm 113 is, for example, a 7-degree-of-freedom arm. A hand 120 capable of gripping the target object is provided at a distal end of the arm 113. The hand 120 is made of a metal material, a resin material, or the like. Examples of the target object include a glass, a cup, a bottle, a plastic bottle, and a paper pack (milk carton). The moving mechanism 115 is a means for moving the main body 110, and includes a wheel, a leg, or the like.

In the present embodiment, the hand 120 of the robot 100 includes a thumb 121 and an index finger 122. The thumb 121 corresponds to, for example, a thumb of the hand 120, and is an example of a first finger. The index finger 122 corresponds to, for example, an index finger of the hand 120, and is an example of a second finger. The thumb 121 has a smaller shape than the index finger 122. In the present embodiment, in order to simplify the description, a case where the hand 120 includes two fingers of the thumb 121 and the index finger 122 will be described. However, the hand may include three or more fingers.

The thumb 121 and the index finger 122 are configured to be movable by an actuator provided in an interphalangeal joint portion. For example, as illustrated in FIG. 2, the index finger 122 is configured to be able to rotate each of a plurality of links 126, 127, and 128 by three first joint portions 123, 124, and 125. The hand 120 is configured such that a distance between the thumb 121 and the index finger 122 can be changed. The thumb 121 is configured to be rotatable about an axis of the arm 113 by a second joint portion 129. The index finger 122 is configured to be rotatable about the axis of the arm 113 by the arm 113.

As illustrated in FIG. 3, a target object 600 is a glass having a circular and smooth curved cross section along the horizontal direction. The target object 600 is placed on a table or the like, for example. In a scene ST1, when the target object 600 is positioned between the thumb 121 and the index finger 122, the hand 120 operates to narrow the distance between the thumb 121 and the index finger 122, thereby gripping the target object 600. In this case, the thumb 121 and the index finger 122 hold a side portion of the target object 600.

In a scene ST2, the hand 120 is stationary with the thumb 121 in contact with the target object 600. The hand 120 is configured such that the index finger 122 can rotate in the direction C1 and the direction C2 about the axis of the second joint portion 129. That is, the hand 120 can be changed so as to trace the contact position between the index finger 122 and the surface of the side portion of the target object 600.

Returning to FIG. 2, in the hand 120, a pressure sensor 13 is provided on flat portions 120F of the thumb 121 and the index finger 122. The flat portion 120F of the thumb 121 has a smaller surface area than the flat portion 120F of the index finger 122. The pressure sensor 13 is provided on each of the flat portions 120F of the thumb 121 and the index finger 122 that come into contact with the target object 600 when the hand 120 grips the target object 600. As the pressure sensor 13, for example, a pressure distribution sensor or the like that measures a two-dimensional distribution of pressure can be used. In a case where the hand 120 grips the target object 600, the pressure sensor 13 provides pressure information capable of identifying a contact position (pressure center) where a force is applied by the target object 600, a displacement amount of a reaction force (deformation) generated according to the force in a two-dimensional plane, and the like. That is, the pressure sensor 13 provides information capable of identifying a change in a contact state among the thumb 121, the index finger 122, and the target object 600.

Note that the hand 120 may have a configuration in which a plurality of pressure sensors are arranged in a matrix and information indicating the pressure detected by each pressure sensor is provided in association with coordinate information in the matrix.

### Configuration of Robot According to Embodiment

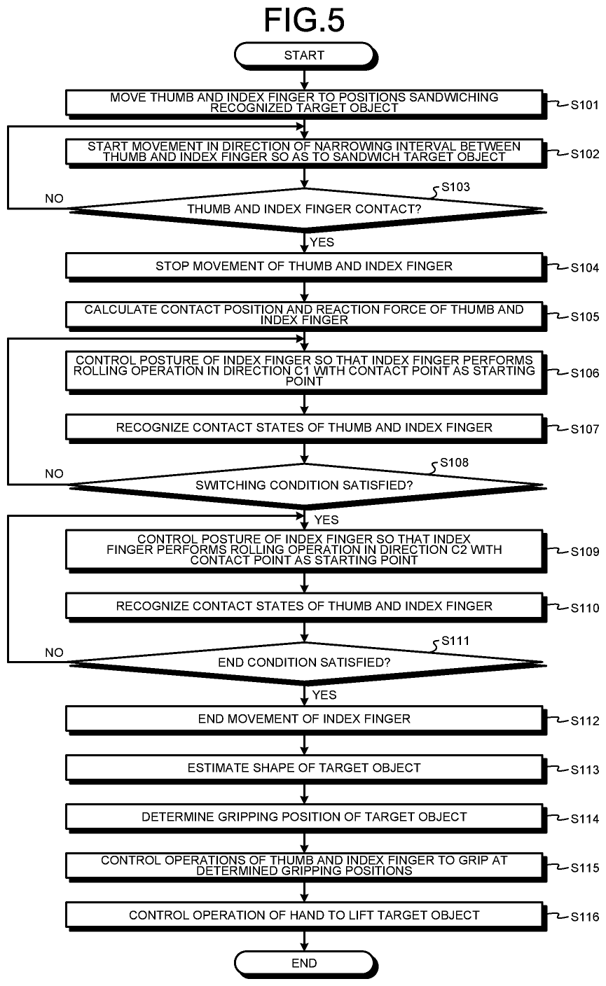

FIG. 4 is a diagram illustrating a configuration example of the robot 100 according to the embodiment. As illustrated in FIG. 4, the robot 100 includes a sensor unit 10, a drive unit 20, an information processing apparatus 30, and a communication unit 40. The information processing apparatus 30 is an example of a control unit of the robot 100 described above. The information processing apparatus 30 is connected to the sensor unit 10, the drive unit 20, and the communication unit 40 so as to be able to exchange data and signals. For example, a case where the information processing apparatus 30 is incorporated in the robot 100 as a unit that controls the operation in the robot 100 will be described, but the information processing apparatus 30 may be provided outside the robot 100. Note that the robot 100 does not need to include the communication unit 40.

The sensor unit 10 includes various sensors and the like that detect information used for processing of the robot 100. The sensor unit 10 supplies the detected information to the information processing apparatus 30 and the like. In the present embodiment, the sensor unit 10 includes the above-described imaging unit 11, a state sensor 12, and the above-described pressure sensor 13. The sensor unit 10 supplies sensor information indicating an image captured by the imaging unit 11 to the information processing apparatus 30. The state sensor 12 includes, for example, a gyro sensor, an acceleration sensor, a surrounding information detection sensor, and the like. The state sensor 12 is provided, for example, on the thumb 121 and the index finger 122. The surrounding information detection sensor detects, for example, an article around the robot 100. The surrounding information detection sensor includes, for example, an ultrasonic sensor, a radar, a light detection and ranging or laser imaging detection and ranging (LiDAR), a sonar, and the like. The sensor unit 10 supplies sensor information indicating a detection result of the state sensor 12 to the information processing apparatus 30. The sensor unit 10 supplies pressure information measured by the pressure sensor 13 to the information processing apparatus 30.

For example, the sensor unit 10 may include various sensors for detecting the current position of the robot 100. Specifically, for example, the sensor unit 10 may include a global positioning system (GPS) receiver, a global navigation satellite system (GNSS) receiver that receives a GNSS signal from a GNSS satellite, and the like. For example, the sensor unit 10 may include a microphone that collects sound around the robot 100.

The drive unit 20 includes various devices related to a drive system of the robot 100. The drive unit 20 includes, for example, a driving force generation device or the like for generating a driving force of a plurality of driving motors or the like. The driving motor operates, for example, the moving mechanism 115 of the robot 100. The moving mechanism 115 includes, for example, functions corresponding to a moving form of the robot 100 such as wheels and legs. The drive unit 20 rotates the driving motor on the basis of control information including a command or the like from the information processing apparatus 30, for example, to autonomously move the robot 100.

The drive unit 20 drives each drivable portion of the robot 100. The drive unit 20 includes an actuator that operates the hand 120 and the like. The drive unit 20 is electrically connected to the information processing apparatus 30 and is controlled by the information processing apparatus 30. The drive unit 20 drives the actuator to move the hand 120 of the robot 100.

The communication unit 40 performs communication between the robot 100 and various external electronic devices, an information processing server, a base station, and the like. The communication unit 40 outputs various types of information received from the information processing server and the like to the information processing apparatus 30, and transmits various types of information from the information processing apparatus 30 to the information processing server and the like. Note that the communication protocol supported by the communication unit 40 is not particularly limited, and the communication unit 40 can support a plurality of types of communication protocols.

The information processing apparatus 30 controls the operation of the robot 100 so as to avoid collision with an obstacle and clean while moving to a target point. The information processing apparatus 30 is, for example, a dedicated or general-purpose computer. The information processing apparatus 30 has a function of controlling a moving operation of the robot 100, a cleaning unit, and the like. The information processing apparatus 30 has a function of controlling the drive unit 20 so as to cause the hand 120 to grip the recognized target object 600 or to pour the liquid in the pot into the target object 600, for example.

The information processing apparatus 30 includes a storage unit 31 and a control unit 32. Note that the information processing apparatus 30 may include at least one of the sensor unit 10 and the communication unit 40 in the configuration.

The storage unit 31 stores various data and programs. For example, the storage unit 31 is, for example, a random access memory (RAM), a semiconductor memory element such as a flash memory, a hard disk, an optical disk, or the like. The storage unit 31 stores, for example, various types of information such as pressure information 311, posture information 312, and model information 313. The pressure information 311 includes, for example, information indicating a measurement result of the pressure sensor 13 in time series. The posture information 312 includes, for example, information capable of identifying the posture of the corresponding index finger 212 during measurement by the pressure sensor 13. The model information 313 includes, for example, information capable of identifying the shape model from the relationship between the pressure distribution and the posture of the index finger 212. The shape model includes, for example, a model obtained by machine learning the shape on the basis of the relationship between the pressure distribution and the posture of the index finger 212.

The control unit 32 includes an operation control unit 321, an estimation unit 322, a determination unit 323, and a recognition unit 324. Each functional unit of the operation control unit 321, the estimation unit 322, the determination unit 323, and the recognition unit 324 is implemented by a central processing unit (CPU), a micro control unit (MPU), or the like executing a program stored inside the information processing apparatus 30 using a RAM or the like as a work area. Furthermore, each functional unit may be implemented by, for example, an integrated circuit such as an application specific integrated circuit (ASIC) or a field-programmable gate array (FPGA).

The operation control unit 321 maintains a state in which the thumb 121 (an example of the first finger) and the index finger 122 (an example of the second finger) grip the target object 600, and operates at least one of the thumb 121 and the index finger 122 to change a posture (contact position) with respect to the target object 600. The operation control unit 321 controls the operation so that the thumb 121 maintains the state of being in contact with the target object 600 and the posture of the index finger 122 changes in the state where the flat portion 120F provided with the pressure sensor 13 is in contact with the target object 600. The operation control unit 321 operates the index finger 122 so that the contact position with the target object 600 and the posture of the index finger 122 change with the contact position of the index finger 122 when gripping the target object 600 as a starting point. For example, as illustrated in FIG. 3, the operation control unit 321 controls the drive unit 20 so that the index finger 122 rotates in the direction C1 or the direction C2 with the starting point as a center.

When the thumb 121 and the index finger 122 grip the target object 600, the operation control unit 321 operates at least one of the thumb 121 and the index finger 122 so as to change the posture with respect to the target object 600 before lifting the target object 600. The operation control unit 321 operates the index finger 122 so as to maintain the reaction force at the contact position of the flat portion 120F and change the contact position with the target object 600 and the posture of the index finger 122.

The estimation unit 322 estimates the shape of the target object 600 on the basis of the relationship between the changing postures and contact positions of the thumb 121 and the index finger 122. The estimation unit 322 estimates the shape of the target object 600 on the basis of the change in the contact position with the target object 600 on the flat portion 120F of the index finger 122 and the posture of the index finger 122. The estimation unit 322 estimates the shape of the target object 600 on the basis of the relationship between the contact positions and the postures based on the pressure distribution in the flat portion 120F.

For example, when the postures of the thumb 121 and the index finger 122 with respect to the target object 600 change, the contact positions change according to the shape of the target object 600. Therefore, the estimation unit 322 estimates a shape having a similar relationship between the posture and the contact position from the target object 600 on the basis of the relationship between the changing postures and the contact positions of the thumb 121 and the index finger 122 and the model information 313. The estimation unit 322 may estimate the cross-sectional shape of the target object 600 at the place where the index finger 122 is in contact for each changing posture of the index finger 122, and estimate the entire shape of the target object 600 on the basis of a plurality of different cross-sectional shapes.

The determination unit 323 determines the gripping positions of the thumb 121 and the index finger 122 on the basis of the estimated shape of the target object 600. The determination unit 323 determines a gripping position suitable for gripping the target object 600 from among a plurality of gripping positions obtained by changing the contact positions of the thumb 121 and the index finger 122. For example, the determination unit 323 determines the gripping position where the area on which the pressure acts is the widest. For example, the determination unit 323 determines the gripping position at which the gravity direction component of the force acting between the target object 600 and the hand 120 is the smallest. For example, the determination unit 323 determines the gripping position where the index finger 122 is closest to the contact position of the thumb 121.

The recognition unit 324 recognizes the presence or absence of an object, the target object 600, or the like around the robot 100 on the basis of image information captured by the imaging unit 11, sensor information of the state sensor 12, or the like. The model information 313 includes a model indicating a shape of an object, the target object 600, or the like. In this case, the recognition unit 324 searches for a model matching or similar to the detected geometric shape from among the plurality of models indicated by the model information 313, and recognizes the presence of the object, the target object 600, and the like when extracting the model.

The functional configuration example of the robot 100 according to the present embodiment has been described above. Note that the above-described configuration described with reference to FIG. 4 is merely an example, and the functional configuration of the robot 100 according to the present embodiment is not limited to such an example. The functional configuration of the robot 100 according to the present embodiment can be flexibly modified according to specifications and operations.

### Processing Procedure of Information Processing Apparatus According to Embodiment

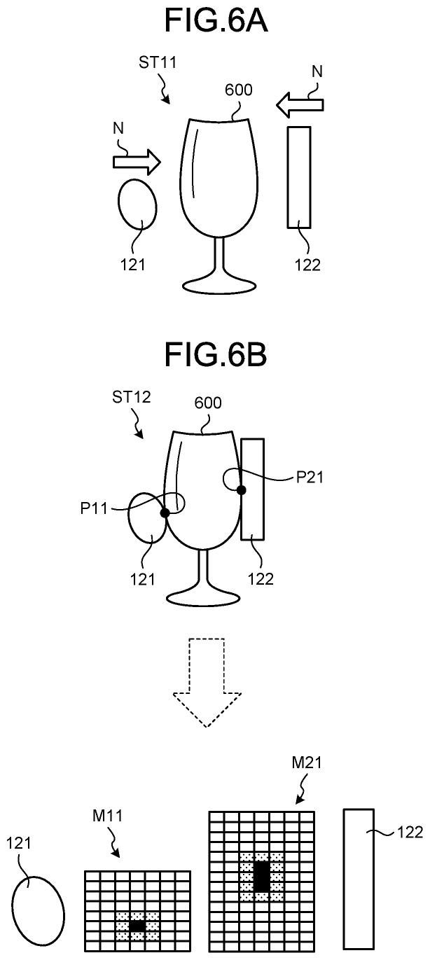

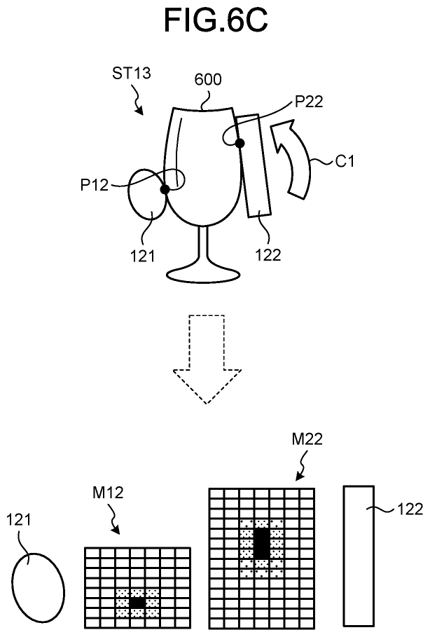

Next, an example of a processing procedure of the information processing apparatus 30 according to the embodiment will be described. FIG. 5 is a flowchart illustrating a processing procedure executed by the information processing apparatus 30 according to the embodiment. FIGS. 6A to 6D are diagrams for explaining the relationship among the thumb 121, the index finger 122, and the pressure distribution under the control of the information processing apparatus 30 according to the embodiment. The processing procedure illustrated in FIG. 5 is realized by the control unit 32 of the information processing apparatus 30 executing a program. The processing procedure illustrated in FIG. 5 is executed by the control unit 32 at a timing, for example, in a case where the target object 600 is recognized, in a case where a start instruction is received from an electronic device outside the information processing apparatus 30, or the like.

As illustrated in FIG. 5, the control unit 32 of the information processing apparatus 30 moves the thumb 121 and the index finger 122 to positions sandwiching the recognized target object 600 (Step S101). For example, the control unit 32 recognizes the target object 600 that can be gripped by the hand 120 on the basis of the sensor information of the sensor unit 10. For example, the control unit 32 controls the drive unit 20 so that the thumb 121 and the index finger 122 of the hand 120 move to a position where the target object 600 can be sandwiched. For example, the control unit 32 performs control to operate the hand 120, the arm 113, and the like such that the vicinity of the center in the height direction of the target object 600 is positioned on a straight line connecting the thumb 121 and the index finger 122. Upon completion of the processing in Step S101, the control unit 32 advances the processing to Step S102.

The control unit 32 starts movement in a direction of narrowing the interval between the thumb 121 and the index finger 122 so as to sandwich the target object 600 (Step S102). For example, as illustrated in a scene ST11 in FIG. 6A, the control unit 32 controls the drive unit 20 so as to start moving the thumb 121 and the index finger 122 in a direction N toward the target object 600. Returning to FIG. 5, when the processing of Step S102 is completed, the control unit 32 advances the processing to Step S103.

The control unit 32 determines whether or not the thumb 121 and the index finger 122 are in contact with the target object 600 on the basis of the pressure information 311 acquired from the pressure sensor 13 (Step S103). For example, the control unit 32 determines that the thumb 121 and the index finger 122 are in contact with each other in a case where both of the pressure information 311 of the thumb 121 and the index finger 122 indicate a pressure at a contact position where a force is applied by the target object 600. In a case where it is determined that the thumb 121 and the index finger 122 are not in contact with the target object 600 (No in Step S103), the control unit 32 returns the processing to Step S102 described above and continues the processing. In addition, in a case where the control unit 32 determines that the thumb 121 and the index finger 122 are in contact with the target object 600 (Yes in Step S103), the control unit 32 advances the processing to Step S104.

The control unit 32 stops the movement of the thumb 121 and the index finger 122 (Step S104). For example, the control unit 32 controls the drive unit 20 so as to stop the movement of the thumb 121 and the index finger 122 in the direction N toward the target object 600. As a result, as illustrated in a scene ST12 in FIG. 6B, the thumb 121 is in contact with the target object 600 at a contact position P11 on the flat portion 120F of the thumb 121. The index finger 122 is in contact with the target object 600 at a contact position P21 on the flat portion 120F of the index finger 122. The thumb 121 and the index finger 122 hold the target object 600. In this case, the pressure sensor 13 of the thumb 121 supplies pressure information 131 indicating a pressure distribution M11 to the control unit 32. The pressure distribution M11 indicates a pressure distribution for an 8×7 region obtained by dividing the detection region of the thumb 121. The pressure distribution M11 indicates that pressure is applied to one region corresponding to the contact position P11 and regions around the region. In addition, the pressure sensor 13 of the index finger 122 supplies pressure information 131 indicating a pressure distribution M21 to the control unit 32. The pressure distribution M21 indicates a pressure distribution for a 14×7 region obtained by dividing the detection region of the index finger 122. The pressure distribution M21 indicates that pressure is applied to three regions corresponding to the contact position P21 and regions around the regions. Returning to FIG. 5, when the processing of Step S104 is completed, the control unit 32 advances the processing to Step S105.

The control unit 32 calculates the contact position/reaction force of the thumb 121 and the index finger 122 (Step S105). For example, the control unit 32 acquires the pressure information 131 indicating the pressure distribution M11 and the pressure distribution M21 of each of the thumb 121 and the index finger 122 from the pressure sensors 13 of the thumb 121 and the index finger 122. For example, the control unit 32 calculates a contact position x_{c} (vector indicating the pressure center) and a contact reaction force F on the flat portion 120F for each of the thumb 121 and the index finger 122 on the basis of the following Formulas (1) and (2). Note that the pressure sensor 13 is assumed to be a pressure distribution sensor.

$$\vec{{x}_{c}} = \frac{{\sum }_{k = 0}^{n} {P}_{k} \vec{{x}_{k}}}{{\sum }_{k = 0}^{n} {P}_{k} Δ s} \qquad FORMULA ( 1 )$$

$$F = {{\sum }^{n}}_{k = 0} {P}_{k} Δ s \qquad FORMULA ( 2 )$$

In the Formulas (1) and (2), k, Pₖ, xₖ (vector), and AS are parameters. k is a cell number (cell ID) of the pressure distribution sensor. Pₖ is a pressure value/force value measured by the cell of the pressure distribution sensor. xₖ (vector) is a position in the pressure distribution (flat portion 120F) of the pressure distribution sensor. The position is based on the center point of the pressure distribution sensor, but the position may be described by another expression method in the link coordinate system of the robot, the base coordinate system of the robot, or the world coordinate system. ΔS is the area of the cell of the pressure distribution sensor or the area ratio with respect to the reference cell. The product of Pₖ and ΔS has a force dimension. In addition, in the pressure distribution sensor, since the cell sizes are equal, the subscript k of ΔS is omitted, but when the size is different for each cell, ΔSₖ may be used.

After storing the calculated contact positions/reaction forces of the thumb 121 and the index finger 122 in the storage unit 31, the control unit 32 advances the processing to Step S106. The control unit 32 controls the posture of the index finger 122 so that the index finger 122 performs the rolling operation in the direction C1 with the contact position as a starting point (Step S106). The rolling operation means an operation of rolling the index finger 122 in a state of being in contact with the surface of the target object 600 with the contact position as a starting point. The rolling operation includes, for example, an operation of rotating the index finger 122 about an axis of the second joint portion 129, the arm 113, or the like in a state where the index finger 122 is in contact with the surface of the target object 600. For example, the control unit 32 controls the rotation of the second joint portion 129 so as to rotate in the direction C1 about the axis of the second joint portion 129. Specifically, the control unit 32 determines the rotational speed of the second joint portion 129 so as to gradually change the posture of the index finger 122, and rotates the second joint portion 129 in the direction C1 at the rotational speed. Upon completion of the processing in Step S106, the control unit 32 advances the processing to Step S107.

The control unit 32 recognizes the contact states of the thumb 121 and the index finger 122 (Step S107). For example, the control unit 32 acquires the pressure information 311 from each of the pressure sensors 13 of the thumb 121 and the index finger 122, and recognizes the contact states in the flat portion 120F on the basis of the pressure information 311. For example, the control unit 32 stores the contact state such as the area to which the pressure is applied, the pressure center, and the magnitude of the pressure in the flat portion 120F in the storage unit 31 in association with the position and posture of the index finger 122 at that time. For example, the control unit 32 specifies the position and posture of the index finger 122 on the basis of an angle at which the second joint portion 129 is controlled, the instructed position, and the like. For example, the control unit 32 may specify the position and posture of the index finger 122 on the basis of information from a torque sensor provided in the second joint portion 129. Upon completion of the processing in Step S107, the control unit 32 advances the processing to Step S108.

The control unit 32 determines whether or not the switching condition is satisfied (Step S108). The switching condition is a condition for switching the moving direction of the index finger 122 from the direction C1 to the direction C2. For example, the control unit 32 determines that the switching condition is satisfied when there is no change in the contact position x_{c} on the flat portion 120F of the index finger 122. The control unit 32, when determining that the switching condition is not satisfied (No in Step S108), returns the processing to Step S106 already described above and continues the processing. In addition, the control unit 32, when determining that the switching condition is satisfied (Yes in Step S108), advances the processing to Step S109.

In this case, as illustrated in a scene ST13 of FIG. 6C, the thumb 121 is in contact with the target object 600 at a contact position P12 on the flat portion 120F of the thumb 121. Since the thumb 121 is not moved, the contact position P12 is the same as the contact position P11. The index finger 122 is in contact with the target object 600 at a contact position P22 on the flat portion 120F of the index finger 122. The thumb 121 and the index finger 122 hold the target object 600. In this case, the pressure sensor 13 of the thumb 121 supplies the pressure information 131 indicating a pressure distribution M12 to the control unit 32. The pressure distribution M12 is identical to the pressure distribution M11. In addition, the pressure sensor 13 of the index finger 122 supplies the pressure information 131 indicating a pressure distribution M22 to the control unit 32. The pressure distribution M22 indicates a pressure distribution for a 14×7 region obtained by dividing the detection region of the index finger 122. The pressure distribution M22 indicates that pressure is applied to a region corresponding to the contact position P22 and regions around the region.

Returning to FIG. 5, the control unit 32 controls the posture of the index finger 122 so that the index finger 122 performs the rolling operation in the direction C2 with the contact position as a starting point (Step S109). That is, the control unit 32 executes the rolling operation of the index finger 122 by switching from the direction C1 to the direction C2. For example, the control unit 32 controls the rotation of the second joint portion 129 so as to rotate in the direction C2 about the axis of the second joint portion 129. Specifically, the control unit 32 determines a rotational speed of the second joint portion 129 so as to gradually change the posture of the index finger 122, and rotates the second joint portion 129 in the direction C2 at the rotational speed. Upon completion of the processing in Step S109, the control unit 32 advances the processing to Step S110.

The control unit 32 recognizes the contact states of the thumb 121 and the index finger 122 (Step S110). For example, as in Step S107 described above, the control unit 32 acquires the pressure information 311 from each of the pressure sensors 13 of the thumb 121 and the index finger 122, and recognizes the contact states on the basis of the pressure information 311. For example, the control unit 32 stores the contact state such as the area to which the pressure is applied, the pressure center, and the magnitude of the pressure in the flat portion 120F in the storage unit 31 in association with the posture information 312 capable of identifying the position and posture of the index finger 122 at that time. Upon completion of the processing in Step S110, the control unit 32 advances the processing to Step S111.

The control unit 32 determines whether or not the switching condition is satisfied (Step S111). The end condition is a condition for ending the movement of the index finger 122 in the direction C2. For example, the control unit 32 determines that the end condition is satisfied when the contact position x_{c} of the index finger 122 traverses the pressure distribution, when the switching condition is satisfied after switching the direction from the direction C1 to the direction C2 once, or when an end instruction is received from an external electronic device. The control unit 32, when determining that the end condition is not satisfied (No in Step S111), returns the processing to Step S109 already described above and continues the processing. In addition, the control unit 32, when determining that the end condition is satisfied (Yes in Step S111), advances the processing to Step S112.

The control unit 32 ends the operation of the index finger 122 (Step S112). For example, the control unit 32 controls the drive unit 20 so as to stop the rolling operation of the index finger 122. As a result, as shown in a scene ST14 of FIG. 6D, the index finger 122 is in contact with the target object 600 at a contact position P23 on the flat portion 120F of the index finger 122. The thumb 121 and the index finger 122 hold the target object 600. In this case, the pressure sensor 13 of the thumb 121 supplies the pressure information 131 indicating a pressure distribution M13 to the control unit 32. The pressure distribution M13 is identical to the pressure distribution M11. In addition, the pressure sensor 13 of the index finger 122 supplies the pressure information 131 indicating a pressure distribution M23 to the control unit 32. The pressure distribution M23 indicates a pressure distribution for a 14×7 region obtained by dividing the detection region of the index finger 122. The pressure distribution M23 indicates that pressure is applied to a region corresponding to the contact position P23 and regions around the region. Returning to FIG. 5, upon completion of the processing of Step S112, the control unit 32 advances the processing to Step S113.

The control unit 32 estimates the shape of the target object 600 (Step S113). For example, the control unit 32 estimates the shape of the target object 600 by tracing the contact state recognized for each of a plurality of different contact positions and the posture information 312 capable of identifying the position and posture of the index finger 122 at that time. For example, the control unit 32 estimates the entire shape of the target object 600 by joining the cross-sectional shapes of the target object 600 at each of the plurality of different contact positions. For example, the control unit 32 specifies a similar shape model from the relationship between the pressure distribution and the posture of the index finger 212, for example, on the basis of the contact state recognized for each of the plurality of different contact positions and the posture information 312 capable of identifying the position and posture of the index finger 122 at that time, and the model information 313, and estimates the shape model as the shape of the target object 600. Upon completion of the processing in Step S113, the control unit 32 advances the processing to Step S114.

The control unit 32 determines the gripping position of the target object 600 (Step S114). For example, on the basis of the estimated shape of the target object 600, the control unit 32 determines the gripping position of the target object 600 so as to satisfy at least one of a posture in which the area of the flat portion 120F on which the pressures of the thumb 121 and the index finger 122 act is the largest, a posture in which the gravity direction component of the force acting between the target object 600 and the hand 120 is the smallest, a posture in which the index finger 122 is closest to the contact position of the thumb 121, and the like. In the present embodiment, since the contact position of the thumb 121 is fixed, the control unit 32 extracts the posture of the index finger 122 having the largest area on the basis of the contact area of the index finger 122 recognized for each of the plurality of contact positions, and determines the contact position of the index finger 122 in the posture as the gripping position. For example, the control unit 32 may obtain the postures of the thumb 121 and the index finger 122 in which the gravity direction component is the smallest on the basis of the acceleration component or the like in the gravity direction measured by the state sensors 12 of the thumb 121 and the index finger 122 and determine the posture as the gripping position of the target object 600. For example, the control unit 32 may obtain the distance between the thumb 121 and the index finger 122 for each of the plurality of different contact positions, and determine the distance as the gripping position of the target object 600 so that the index finger 122 is in a posture closest to the contact position of the thumb 121. When storing the determined gripping position in the storage unit 31, the control unit 32 advances the processing to Step S115.

The control unit 32 controls the operations of the thumb 121 and the index finger 122 so as to grip the target object 600 at the determined gripping positions (Step S115). For example, the control unit 32 obtains contact positions of the thumb 121 and the index finger 122 with respect to the target object 600 corresponding to the gripping positions, and performs control to operate the hand 120, the arm 113, and the like so as to move from the current positions to the contact positions. Specifically, the control unit 32 obtains a movement plan from the current positions to the contact positions of the thumb 121 and the index finger 122, and controls the drive unit 20 on the basis of the movement plan. For example, in a case where the control unit 32 determines the contact positions illustrated in a scene ST14 of FIG. 6D as the gripping positions, the control unit 32 positions the thumb 121 and the index finger 122 such that the thumb 121 comes into contact with the target object 600 at the contact position P13 and the index finger 122 comes into contact with the target object 600 at the contact position P23. As a result, the robot 100 can grip the target object 600 by the thumb 121 and the index finger 122 at the gripping positions suitable for the shape of the target object 600. Returning to FIG. 5, upon completion of the processing of Step S115, the control unit 32 advances the processing to Step S116.

The control unit 32 controls the operation of the hand 120 so as to lift the target object 600 (Step S116). For example, the control unit 32 controls the drive unit 20 so that the hand 120 moves upward in a state where the thumb 121 and the index finger 122 grip the target object 600. As a result, the robot 100 can lift the target object 600 gripped by the thumb 121 and the index finger 122. Upon completion of the processing in Step S116, the control unit 32 ends the processing procedure illustrated in FIG. 5.

In the processing procedure illustrated in FIG. 5 described above, in order to simplify the description, the case where the control unit 32 fixes and does not move the thumb 121 has been described. However, a processing procedure for moving the thumb 121 may be added. In a case where the index finger 122 is moved in the direction C2 after being moved in the direction C1, the processing procedure illustrated in FIG. 5 may be a processing procedure of moving the index finger 122 in the direction C1 after being moved in the direction C2.

### Exemplary Operation of Hand By Information Processing Apparatus According to Embodiment

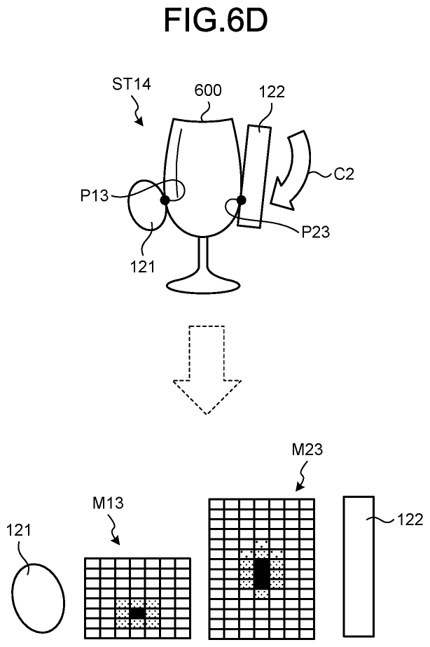

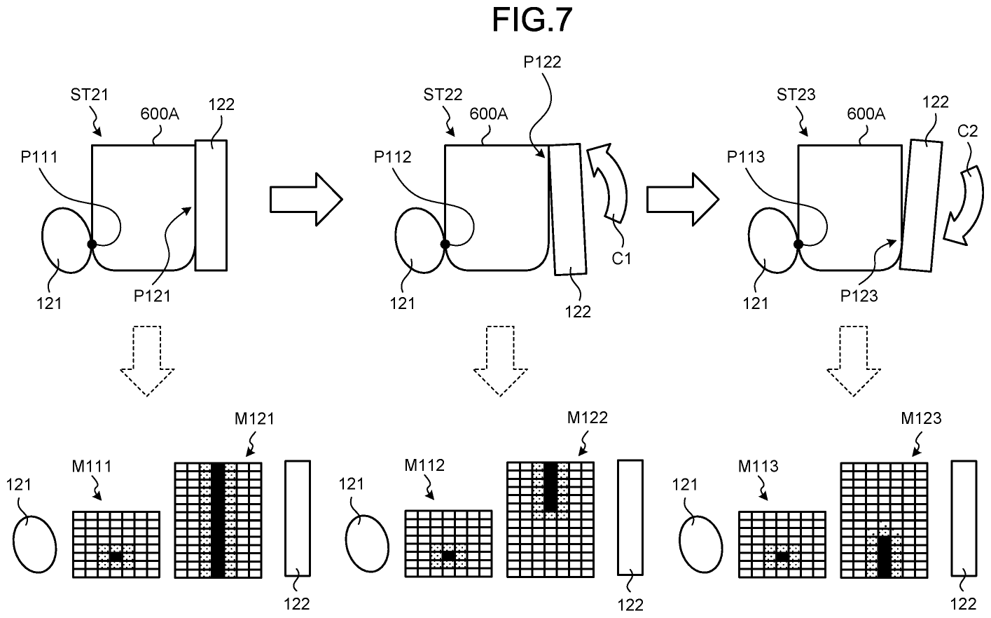

FIGS. 7 and 8 are diagrams for explaining the relationship among the thumb 121, the index finger 122, and the pressure distribution under the control of the information processing apparatus 30 according to the embodiment.

In the example illustrated in FIG. 7, a target object 600A is a glass having a cylindrical side portion. In a scene ST21 illustrated in FIG. 7, the information processing apparatus 30 brings the thumb 121 into contact with the target object 600A at a contact position P111 in the flat portion 120F. The information processing apparatus 30 brings the index finger 122 into contact with the target object 600A at a contact position P121 in the flat portion 120F. Since the target object 600A has a cylindrical shape, the flat portion 120F of the index finger 122 is in contact with the side portion of the target object 600A from the upper portion to the lower portion. The thumb 121 and the index finger 122 hold the target object 600A. In this case, the information processing apparatus 30 acquires the pressure information 131 indicating the pressure distribution M111 from the pressure sensor 13 of the thumb 121, and acquires the pressure information 131 indicating the pressure distribution M121 from the pressure sensor 13 of the index finger 122. The pressure information 131 indicating the pressure distribution M111 indicates that pressure is applied to one region corresponding to the contact position P111 and regions around the region. The pressure information 131 indicating the pressure distribution M121 indicates that pressure is applied to 14 continuous regions corresponding to the linear contact position P121 and the left and right regions thereof. The information processing apparatus 30 calculates a contact position x_{c} (vector indicating the pressure center) and a contact reaction force F in the pressure distributions M111 and M121 for each of the thumb 121 and the index finger 122, and stores the contact position x_{c} and the contact reaction force F in the storage unit 31 in association with the position and posture of the index finger 122 at that time.

Thereafter, as illustrated in a scene ST22, the information processing apparatus 30 causes the index finger 122 to perform a rolling operation in the direction C1, and the index finger 122 is brought into contact with the upper side of the side portion of the target object 600A at a contact position P122 in the flat portion 120F. The information processing apparatus 30 brings the thumb 121 into contact with the target object 600A at a contact position P112 in the flat portion 120F. In the present embodiment, since the thumb 121 is not moved, the contact position P112 is the same contact position as the contact position P111. In this case, the information processing apparatus 30 acquires the pressure information 131 indicating a pressure distribution M112 from the pressure sensor 13 of the thumb 121, and acquires the pressure information 131 indicating a pressure distribution M122 from the pressure sensor 13 of the index finger 122. The pressure information 131 indicating the pressure distribution M112 indicates that pressure is applied to one region corresponding to the contact position P112 and regions around the region. The pressure information 131 indicating the pressure distribution M122 indicates that pressure is applied to six continuous regions corresponding to the contact position P122 indicating the upper side of the side portion of the target object 600A and regions around the regions. The information processing apparatus 30 calculates a contact position x_{c} (vector indicating the pressure center) and a contact reaction force F in the pressure distributions M112 and M122 for each of the thumb 121 and the index finger 122, and stores the contact position x_{c} and the contact reaction force F in the storage unit 31 in association with the position and posture of the index finger 122 at that time.

Thereafter, as illustrated in a scene ST23, the information processing apparatus 30 causes the index finger 122 to perform a rolling operation in the direction C2, and the index finger 122 is brought into contact with the lower side of the side portion of the target object 600A at a contact position P123 in the flat portion 120F. The information processing apparatus 30 brings the thumb 121 into contact with the target object 600A at a contact position P113 in the flat portion 120F. In the present embodiment, since the thumb 121 is not moved, the contact position P113 is the same as the contact positions P111 and P112. In this case, the information processing apparatus 30 acquires the pressure information 131 indicating a pressure distribution M113 from the pressure sensor 13 of the thumb 121, and acquires the pressure information 131 indicating a pressure distribution M123 from the pressure sensor 13 of the index finger 122. The pressure information 131 indicating the pressure distribution M113 indicates that pressure is applied to one region corresponding to the contact position P113 and regions around the region. The pressure information 131 indicating the pressure distribution M123 indicates that pressure is applied to five continuous regions corresponding to the contact position P123 indicating the lower side of the side portion of the target object 600A and regions around the regions. The information processing apparatus 30 calculates a contact position x_{c} (vector indicating the pressure center) and a contact reaction force F in the pressure distributions M113 and M123 for each of the thumb 121 and the index finger 122, and stores the contact position x_{c} and the contact reaction force F in the storage unit 31 in association with the position and posture of the index finger 122 at that time.

The information processing apparatus 30 estimates that the target object 600A has a cylindrical shape on the basis of the contact state of the index finger 122 at a plurality of different contact positions P121, P122, P123, and the like, the position and posture of the index finger 122 at that time, and the like. Since the information processing apparatus 30 estimates that the shape of the target object 600A is cylindrical, the information processing apparatus 30 determines the vicinities of the center of the side portions of the target object 600A as the gripping positions at which the thumb 121 and the index finger 122 grip the target object 600A. The information processing apparatus 30 positions the thumb 121 and the index finger 122 at the determined gripping positions, and causes the thumb 121 and the index finger 122 to grip the target object 600A. As a result, the information processing apparatus 30 can cause the hand 120 to grip the target object 600A at the positions suitable for the shape of the cylindrical target object 600A.

Next, in the example illustrated in FIG. 8, a target object 600B is a glass having a tapered lower portion. In a scene ST31 illustrated in FIG. 8, the information processing apparatus 30 brings the thumb 121 into contact with the target object 600B at a contact position P211 in the flat portion 120F. The information processing apparatus 30 brings the index finger 122 into contact with the target object 600B at a contact position P221 in the flat portion 120F. Since the side portion of the target object 600B has a tapered shape, the flat portion 120F of the index finger 122 is in contact with the vicinity of the upper end of the side portion of the target object 600A. The thumb 121 and the index finger 122 hold the target object 600B. In this case, the information processing apparatus 30 acquires the pressure information 131 indicating a pressure distribution M211 from the pressure sensor 13 of the thumb 121, and acquires the pressure information 131 indicating a pressure distribution M221 from the pressure sensor 13 of the index finger 122. The pressure information 131 indicating the pressure distribution M211 indicates that pressure is applied to one region corresponding to the contact position P211 and regions around the region. The pressure information 131 indicating the pressure distribution M221 indicates that pressure is applied to two continuous regions corresponding to the contact position P221 and regions around the regions. The information processing apparatus 30 calculates a contact position x_{c} (vector indicating the pressure center) and a contact reaction force F in the pressure distributions M211 and M221 for each of the thumb 121 and the index finger 122, and stores the contact position x_{c} and the contact reaction force F in the storage unit 31 in association with the position and posture of the index finger 122 at that time.

Thereafter, as illustrated in a scene ST32, the information processing apparatus 30 causes the index finger 122 to perform a rolling operation in the direction C1, and the index finger 122 is brought into contact with the upper end of the side portion of the target object 600B at a contact position P222 in the flat portion 120F. The information processing apparatus 30 brings the thumb 121 into contact with the target object 600B at a contact position P212 in the flat portion 120F. In the present embodiment, since the thumb 121 is not moved, the contact position P212 is the same contact position as the contact position P211. In this case, the information processing apparatus 30 acquires the pressure information 131 indicating a pressure distribution M212 from the pressure sensor 13 of the thumb 121, and acquires the pressure information 131 indicating a pressure distribution M222 from the pressure sensor 13 of the index finger 122. The pressure information 131 indicating the pressure distribution M212 indicates that pressure is applied to one region corresponding to the contact position P212 and regions around the region. The pressure information 131 indicating the pressure distribution M222 indicates that pressure is applied to two continuous regions corresponding to the contact position P222 indicating the vicinity of the upper end of the side portion of the target object 600A and regions around the regions. That is, since the index finger 122 cannot move in the direction C1, the pressure information 131 indicating the pressure distribution M222 has the same pressure distribution as the pressure information 131 indicated by the pressure distribution M221. The information processing apparatus 30 calculates a contact position x_{c} (vector indicating the pressure center) and a contact reaction force F in the pressure distributions M212 and M222 for each of the thumb 121 and the index finger 122, and stores the contact position x_{c} and the contact reaction force F in the storage unit 31 in association with the position and posture of the index finger 122 at that time.

Thereafter, as illustrated in a scene ST33, the information processing apparatus 30 causes the index finger 122 to perform a rolling operation in the direction C2, and the index finger 122 is brought into contact with the upper side of the side portion of the target object 600B at a contact position P223 in the flat portion 120F. The information processing apparatus 30 brings the thumb 121 into contact with the target object 600B at a contact position P213 in the flat portion 120F. In the present embodiment, since the thumb 121 is not moved, the contact position P213 is the same as the contact positions P211 and P212. In this case, the information processing apparatus 30 acquires the pressure information 131 indicating a pressure distribution M213 from the pressure sensor 13 of the thumb 121, and acquires the pressure information 131 indicating a pressure distribution M223 from the pressure sensor 13 of the index finger 122. The pressure information 131 indicating the pressure distribution M213 indicates that pressure is applied to one region corresponding to the contact position P213 and regions around the region. The pressure information 131 indicating the pressure distribution M223 indicates that pressure is applied to four continuous regions corresponding to the contact position P223 indicating the upper side of the side portion of the target object 600B and regions around the regions. The information processing apparatus 30 calculates a contact position x_{c} (vector indicating the pressure center) and a contact reaction force F in the pressure distributions M213 and M223 for each of the thumb 121 and the index finger 122, and stores the contact position x_{c} and the contact reaction force F in the storage unit 31 in association with the position and posture of the index finger 122 at that time.

The information processing apparatus 30 estimates that the target object 600B has an inverted truncated cone shape on the basis of the contact state of the index finger 122 at a plurality of different contact positions P221, P222, P223, and the like, the position and posture of the index finger 122 at that time, and the like. Since the information processing apparatus 30 estimates that the target object 600B has an inverted truncated cone shape, the information processing apparatus 30 determines portions from the center to the vicinity of the lower side of the side portions of the target object 600A as the gripping positions at which the thumb 121 and the index finger 122 grip the target object 600A. The information processing apparatus 30 positions the thumb 121 and the index finger 122 at the determined gripping positions, and causes the thumb 121 and the index finger 122 to grip the target object 600B. As a result, the information processing apparatus 30 can cause the hand 120 to grip the target object 600B at positions suitable for the shape of the target object 600B having an inverted truncated cone shape.

### Modification (1) of Embodiment

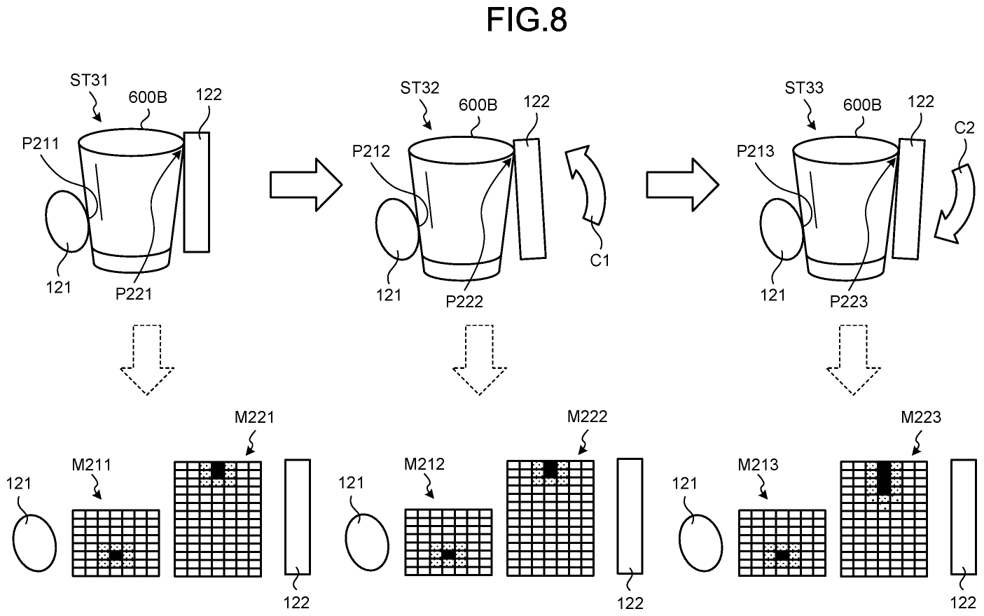

Next, an example of information processing of the information processing apparatus 30 according to Modification (1) of the embodiment will be described. FIG. 9 is a flowchart illustrating a processing procedure executed by an information processing apparatus 30 according to a modification (1) of the embodiment. The processing procedure illustrated in FIG. 9 is implemented by the control unit 32 of the information processing apparatus 30 executing a program. The processing procedure illustrated in FIG. 9 is executed by the control unit 32 at a timing, for example, in a case where the target object 600 is recognized, in a case where a start instruction is received from an external electronic device, or the like.

In the processing procedure illustrated in FIG. 9, the processing from Step S101 to Step S116 is the same as the processing from Step S101 to Step S116 illustrated in FIG. 5, and thus a detailed description thereof will be omitted.

As illustrated in FIG. 9, the control unit 32 of the information processing apparatus 30 moves the thumb 121 and the index finger 122 to positions sandwiching the recognized target object 600 (Step S101). The control unit 32 starts movement in a direction of narrowing the interval between the thumb 121 and the index finger 122 so as to sandwich the target object 600 (Step S102). The control unit 32 determines whether or not the thumb 121 and the index finger 122 are in contact with the target object 600 on the basis of the pressure information 311 acquired from the pressure sensor 13 (Step S103). In a case where it is determined that the thumb 121 and the index finger 122 are not in contact with the target object 600 (No in Step S103), the control unit 32 returns the processing to Step S102 described above and continues the processing. In addition, in a case where the control unit 32 determines that the thumb 121 and the index finger 122 are in contact with the target object 600 (Yes in Step S103), the control unit 32 advances the processing to Step S104.

The control unit 32 stops the movement of the thumb 121 and the index finger 122 (Step S104). The control unit 32 calculates the contact position/reaction force of the thumb 121 and the index finger 122 (Step S105). Upon completion of the processing in Step S105, the control unit 32 advances the processing to Step S120.

The control unit 32 determines whether or not a lifting condition is satisfied (Step S120). The lifting condition is, for example, a condition for determining whether or not lifting is possible on the basis of a contact state between the thumb 121 and the index finger 122 and the target object 600. For example, the control unit 32 obtains the contact area of each of the thumb 121 and the index finger 122 on the basis of the pressure distribution of each of the thumb and the index finger, and determines that the lifting condition is satisfied when the contact area is larger than a preset threshold.

The control unit 32, when determining that the lifting condition is satisfied (Yes in Step S120), advances the processing to Step S116 described above. In this case, the thumb 121 and the index finger 122 can secure a contact area capable of lifting the target object 600. Therefore, the control unit 32 controls the operation of the hand 120 so as to lift the target object 600 (Step S116). For example, the control unit 32 controls the drive unit 20 so that the hand 120 moves upward in a state where the thumb 121 and the index finger 122 grip the target object 600. As a result, the robot 100 can lift the target object 600 gripped by the thumb 121 and the index finger 122 without performing processing of recognizing the shape of the target object 600. Upon completion of the processing in Step S116, the control unit 32 ends the processing procedure illustrated in FIG. 9.

In addition, the control unit 32, when determining that the lifting condition is not satisfied (No in Step S120), advances the processing to Step S106 described above. By executing a series of processing from Step S106 to Step S116, the control unit 32 estimates the shape of the target object 600, determines the gripping positions according to the shape, and controls the operation of lifting the target object 600 gripped at the gripping positions.

As described above, in a case where the contact state of the thumb 121 and the index finger 122 with the target object 600 satisfies the lifting condition, the information processing apparatus 30 can lift the target object 600 without estimating the shape of the target object 600. Furthermore, in a case where the contact state of the thumb 121 and the index finger 122 with the target object 600 does not satisfy the lifting condition, the information processing apparatus 30 estimates the shape of the target object 600 and can lift the target object 600 in a state of gripping the target object 600 at gripping positions suitable for the shape of the target object 600. As a result, the information processing apparatus 30 switches whether or not to estimate the shape of the target object 600 according to the gripping state of the thumb 121 and the index finger 122, so that it is possible to improve the efficiency of the operation of lifting the target object 600.

### Modification (2) of Embodiment

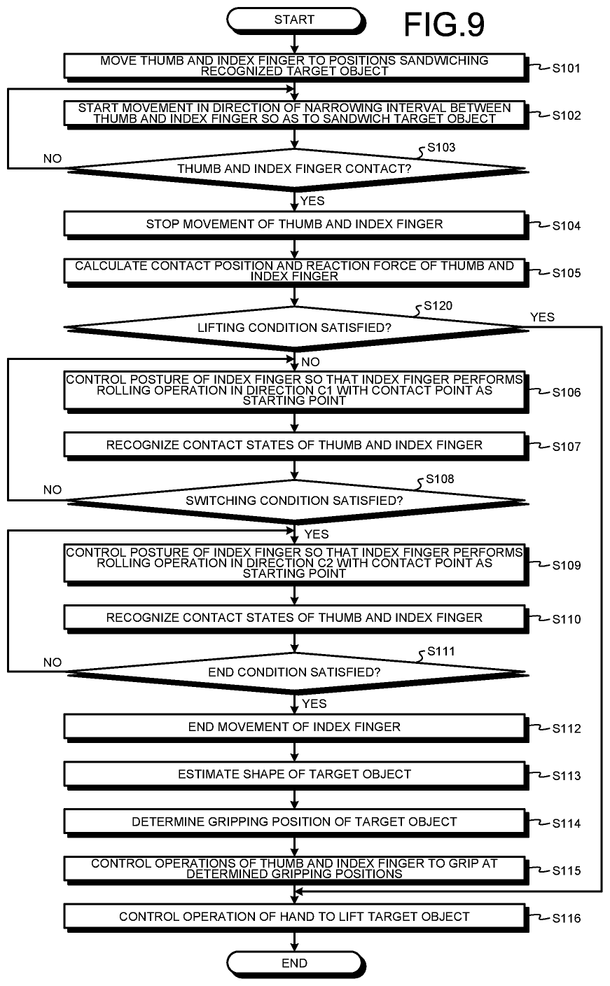

Next, an example of information processing of the information processing apparatus 30 according to Modification (2) of the embodiment will be described. FIG. 10 is a view illustrating an example of a configuration of a hand 120 according to a modification (2) of the embodiment.

As illustrated in FIG. 10, the hand 120 has a thumb 121 and an index finger 122. The index finger 122 is configured to be able to rotate each of the plurality of links 126, 127, and 128 by the three first joint portions 123, 124, and 125. The index finger 122 is configured to be rotatable about an axis of the arm 113 by the second joint portion 129. The thumb 121 is provided on the arm 113, and is configured to be rotatable about the axis of the arm 113. The information processing apparatus 30 controls the drive unit 20 so as to rotate each of the thumb 121 and the index finger 122.

### Modification (3) of Embodiment

In the above-described embodiment, the case where the information processing apparatus 30 estimates the shape of the target object 600 by changing the posture of the index finger 122 with the thumb 121 and the index finger 122 each at one gripping position has been described, but the present invention is not limited thereto. The information processing apparatus 30 may estimate the shape of the target object 600 by changing the posture of the index finger 122 for each of the plurality of gripping positions of the target object 600.

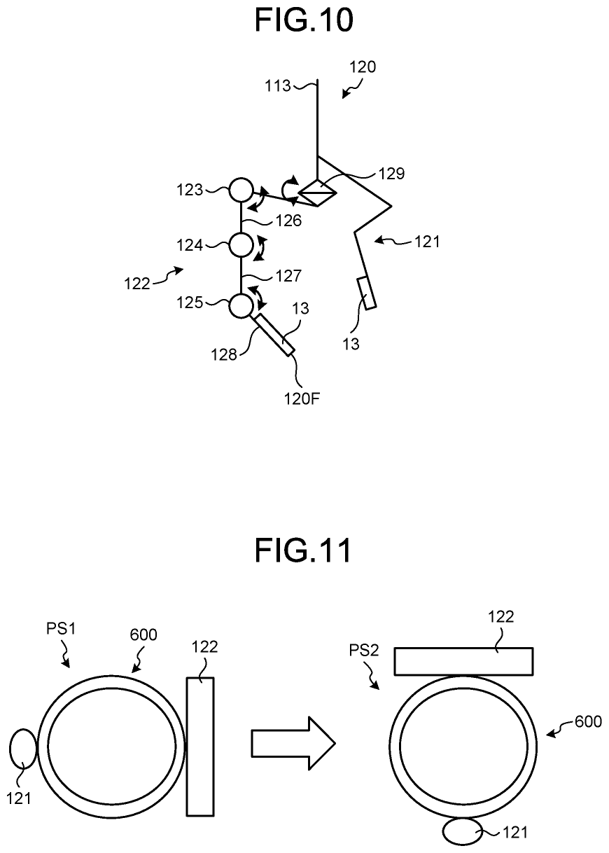

FIG. 11 is a diagram for explaining an example of information processing of an information processing apparatus 30 according to a modification (3) of the embodiment. As illustrated in FIG. 11, the information processing apparatus 30 causes the thumb 121 and the index finger 122 to grip the target object 600 in a gripping pattern PS1. In this state, as described above, the information processing apparatus 30 changes the posture of the index finger 122 and estimates the shape of the target object 600 in the gripping pattern PS1. Then, the information processing apparatus 30 moves the thumb 121 and the index finger 122 in the counterclockwise direction along the periphery of the target object 600, and causes the thumb 121 and the index finger 122 to grip the target object 600 in a gripping pattern PS2. In this state, as described above, the information processing apparatus 30 changes the posture of the index finger 122 and estimates the shape of the target object 600 in the gripping pattern PS2.

For example, in a case where the estimation results of the shape of the target object 600 in the gripping pattern PS1 and the gripping pattern PS2 match, the information processing apparatus 30 determines the estimation result of the shape of the target object 600. For example, in a case where the estimation results of the shape of the target object 600 in the gripping pattern PS1 and the gripping pattern PS2 do not match, the information processing apparatus 30 may move the thumb 121 and the index finger 122 around the target object 600 in the counterclockwise direction and estimate the shape of the target object 600 with different gripping patterns. As described above, the information processing apparatus 30 can improve the accuracy of the estimation result by estimating the shape of the target object 600 with a plurality of different gripping patterns. Furthermore, the information processing apparatus 30 can estimate various shapes of the target object 600 as the number of gripping patterns is increased.

### Other Modifications of Embodiment

In the embodiment, the case where the information processing apparatus 30 controls the robot 100 including one thumb 121 and one index finger 122 has been described, but the present invention is not limited thereto. For example, the information processing apparatus 30 may be configured to control a robot including one thumb 121 and a plurality of index fingers 122, a manipulator, or the like. That is, the information processing apparatus 30 may be configured to estimate the shape of the target object 600 by changing at least one posture of the plurality of index fingers 122 brought into contact with the target object 600. In this case, the information processing apparatus 30 may change the posture of each of the plurality of index fingers 122, or may change the posture as a substantially flat surface in which the plurality of index fingers 122 are linearly arranged and fixed.

In the embodiment, the case where the information processing apparatus 30 is realized as an apparatus that controls the robot 100 has been described, but the present invention is not limited thereto. The information processing apparatus 30 may be realized by a remote device that remotely operates the robot 100, a server device, or the like. Furthermore, the information processing apparatus 30 may be realized by, for example, an injection device that injects contents into a container, a control device that controls a surgical or industrial manipulator, or the like.

Note that the above-described embodiment and the modifications (1) to (3) can be appropriately combined.

### Hardware Configuration

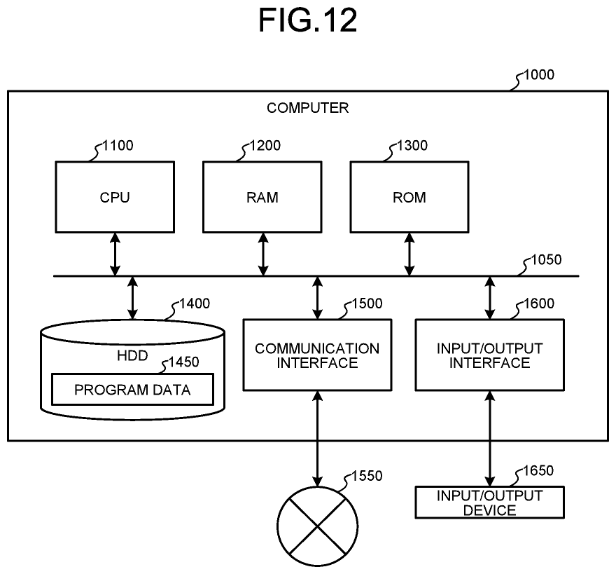

The information processing apparatus 30 according to the above-described embodiment may be realized by a computer 1000 having a configuration as illustrated in FIG. 12, for example. Hereinafter, the information processing apparatus 30 according to the embodiment will be described as an example. FIG. 12 is a hardware configuration diagram illustrating an example of a computer 1000 that implements functions of the information processing apparatus 30. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-transiently records a program executed by the CPU 1100, data used by the program, and the like. Specifically, the HDD 1400 is a recording medium that records an information processing program according to the present disclosure as an example of program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard and a mouse via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD), a magneto-optical recording medium such as a magneto-optical disk (MO), a tape medium, a magnetic recording medium, a semiconductor memory, or the like.

For example, in a case where the computer 1000 functions as the information processing apparatus 30 according to the embodiment, the CPU 1100 of the computer 1000 executes a program loaded on the RAM 1200 to implement the functions of the operation control unit 321, the estimation unit 322, the determination unit 323, the recognition unit 324, and the like. In addition, the HDD 1400 stores a program according to the present disclosure and data in the storage unit 31. Note that the CPU 1100 reads the program data 1450 from the HDD 1400 and executes the program data, but as another example, these programs may be acquired from another device via the external network 1550.

Although the preferred embodiments of the present disclosure have been described in detail with reference to the accompanying drawings, the technical scope of the present disclosure is not limited to such examples. It is obvious that a person having ordinary knowledge in the technical field of the present disclosure can conceive various changes or modifications within the scope of the technical idea described in the claims, and it is naturally understood that these also belong to the technical scope of the present disclosure.

Furthermore, the effects described in the present specification are merely illustrative or exemplary, and are not restrictive. That is, the technology according to the present disclosure can exhibit other effects obvious to those skilled in the art from the description of the present specification together with or instead of the above effects.

Furthermore, it is also possible to create a program for causing hardware such as a CPU, a ROM, and a RAM built in a computer to exhibit a function equivalent to the configuration of the information processing apparatus 30, and a computer-readable recording medium recording the program can also be provided.

Furthermore, each step related to the processing of the information processing apparatus 30 of the present specification is not necessarily processed in time series in the order described in the flowchart. For example, each step related to the processing of the information processing apparatus 30 may be processed in an order different from the order described in the flowchart, or may be processed in parallel.

### EFFECTS

The information processing apparatus 30 includes: an operation control unit 321 that operates at least one of the thumb 121 and the index finger 122 so that a contact position with respect to the target object 600 changes in a state where the thumb 121 (first finger) and the index finger 122 (second finger) grip the target object 600; and an estimation unit 322 that estimates a shape of the target object 600 on the basis of a relationship between contact positions and postures of the thumb 121 and the index finger 122.

As a result, the information processing apparatus 30 can estimate the shape of the target object 600 by operating to change the contact position of at least one of the thumb 121 and the index finger 122 gripping the target object 600. As a result, the information processing apparatus 30 can easily estimate the shape of the gripped target object 600, and thus can grip the target object 600 having various shapes. Furthermore, since the information processing apparatus 30 can estimate the shape of the target object 600 on the basis of the contact positions and postures of the thumb 121 and the index finger 122, it is not necessary to use a non-contact sensor or the like, and the cost of the hand can be suppressed. Furthermore, the information processing apparatus 30 estimates the shape of the target object 600 on the basis of the contact positions and postures of the thumb 121 and the index finger 122, so that it is possible to suppress the influence of the property of the target object such as transparency and opacity, for example.

In the information processing apparatus 30, the index finger 122 has a flat portion 120F provided in a portion facing the thumb 121 that grips the target object 600, and the operation control unit 321 moves the index finger 122 so that the posture of the index finger 122 changes in a state of maintaining a state in which the thumb 121 is in contact with the target object 600 and in a state in which the flat portion 120F of the index finger 122 is in contact with the target object 600.

As a result, the information processing apparatus 30 can estimate the shape of the target object 600 by changing the posture of the index finger 122 in a state where the flat portion 120F of the index finger 122 is in contact with the target object 600 in a state where the thumb 121 is in contact with the target object 600. As a result, since the information processing apparatus 30 only needs to change the posture of the flat portion 120F of the index finger 122, the control can be simplified, and the work space of the thumb 121 and the index finger 122 that grip the target object 600 can be suppressed.

In the information processing apparatus 30, the estimation unit 322 estimates the shape of the target object 600 on the basis of the change in the contact position of the index finger 122 with the target object 600 in the flat portion 120F and the posture of the index finger 122.

As a result, the information processing apparatus 30 can estimate the shape of the target object 600 by changing the posture of the index finger 122 so as to change the contact state between the flat portion 120F of the index finger 122 and the target object 600. As a result, the information processing apparatus 30 can improve the accuracy of estimating the shape of the target object 600 by focusing on the change in the contact position and the posture of the index finger 122 in the flat portion 120F.

In the information processing apparatus 30, the operation control unit 321 operates the index finger 122 so that the contact position with the target object 600 and the posture of the index finger 122 change with the contact position of the index finger 122 when gripping the target object 600 as a starting point.

As a result, the information processing apparatus 30 can change the posture of the index finger 122 starting with the contact position of the index finger 122 when gripping the target object 600 as a starting point. As a result, the possibility that the information processing apparatus 30 can change the posture of the index finger 122 in a state where the index finger 122 is in contact with the surface of the target object 600 is improved, so that the accuracy of the estimated shape of the target object 600 can be improved.

In the information processing apparatus 30, when the thumb 121 and the index finger 122 grip the target object 600, the operation control unit 321 operates at least one of the thumb 121 and the index finger 122 so that a contact position with respect to the target object 600 changes before lifting the target object 600.

As a result, the information processing apparatus 30 can estimate the shape of the target object 600 before lifting the target object 600 gripped by the thumb 121 and the index finger 122. As a result, even if the posture of the index finger 122 is changed, the information processing apparatus 30 can improve safety since the gripped target object 600 does not fall.

In the information processing apparatus 30, the flat portion 120F is provided with the pressure sensor 13 capable of detecting the pressure distribution, and the estimation unit 322 estimates the shape of the target object 600 on the basis of the relationship between the contact position and the posture based on the pressure distribution.

As a result, the information processing apparatus 30 can more accurately detect the contact position between the target object 600 and the index finger 122 on the basis of the pressure distribution of the flat portion 120F. As a result, since the relationship between the contact position and the posture of the index finger 122 in the flat portion 120F is also accurate, the information processing apparatus 30 can improve the accuracy of estimating the shape of the target object 600.

In the information processing apparatus 30, the operation control unit 321 operates the index finger 122 so that a reaction force is generated at the contact position of the flat portion 120F even if the contact position with the target object 600 and the posture of the index finger 122 are changed.

As a result, the information processing apparatus 30 can generate the reaction force with which the target object 600 is in contact even if the contact position between the target object 600 and the flat portion 120F and the posture of the index finger 122 are changed. As a result, the information processing apparatus 30 can maintain the contact state between the flat portion 120F and the target object 600, and thus can maintain the gripping states of the thumb 121 and the index finger 122.

In the information processing apparatus 30, the operation control unit 321 changes the posture of the index finger 122 in the direction C1 (first direction) from the starting point, and changes the posture of the index finger 122 in the direction C2 (second direction) different from the direction C1 when the pressure distribution between the index finger 122 and the target object 600 satisfies the switching condition.

As a result, even if the information processing apparatus 30 changes the posture of the index finger 122 in the direction C1 with the contact point between the target object 600 and the index finger 122 as a starting point, if the pressure distribution satisfies the switching condition, the posture of the index finger 122 can be changed in the direction C2. As a result, since the information processing apparatus 30 can confirm the contact state between the target object 600 and the index finger 122 in a wide range, the accuracy of estimating the shape of the target object 600 can be further improved.

In the information processing apparatus 30, the operation control unit 321 changes the posture of the index finger 122 in the direction C2, and ends the change in the posture of the index finger 122 when the pressure distribution between the index finger 122 and the target object 600 satisfies the end condition.

As a result, even if the posture of the index finger 122 is changed in the direction C2, if the pressure distribution between the index finger 122 and the target object 600 satisfies the end condition, the information processing apparatus 30 can end the change in the posture of the index finger 122. As a result, since the information processing apparatus 30 can end the change in the posture of the index finger 122 according to the pressure distribution between the index finger 122 and the target object 600, the information processing apparatus 30 can efficiently estimate the shape of the target object 600.

The information processing apparatus 30 further includes a determination unit 323 that determines gripping positions of the thumb 121 and the index finger 122 on the basis of the shape of the target object 600 estimated by the estimation unit 322, and the operation control unit 321 controls the operations of the thumb 121 and the index finger 122 so as to grip at the gripping positions.

As a result, the information processing apparatus 30 can verify the gripping positions based on the estimated shape of the target object 600 and cause the thumb 121 and the index finger 122 to grip the target object 600 at the gripping positions. As a result, the information processing apparatus 30 can stabilize gripping of the target object 600 by gripping the target object 600 at the gripping positions based on the shape of the target object 600.

In the information processing apparatus 30, when the thumb 121 and the index finger 122 grip the target object 600 at the gripping positions, the operation control unit 321 operates the hand provided with the thumb 121 and the index finger 122 so as to lift the target object 600.

As a result, the information processing apparatus 30 can cause the hand 120 to lift the target object 600 after causing the thumb 121 and the index finger 122 to grip the target object 600 at the gripping positions based on the shape of the target object 600. As a result, the information processing apparatus 30 can lift the target object 600 safely by gripping the target object 600 at the gripping positions based on the shape of the target object 600 and then lifting the target object 600.

An information processing method includes operating, by a computer, at least one of the thumb 121 and the index finger 122 to change contact positions with the target object 600 in a state where the thumb 121 and the index finger 122 grip the target object 600; and estimating, by the computer, the shape of the target object 600 on the basis of the relationship between the contact positions and postures of the thumb 121 and the index finger 122.

As a result, in the information processing method, the shape of the target object 600 can be estimated by the computer by causing the thumb 121 and the index finger 122 to operate so as to change the contact position of at least one of the thumb 121 and the index finger 122 that grip the target object 600. As a result, the information processing method can easily estimate the shape of the gripped target object 600, so that the target object 600 having various shapes can be gripped. Furthermore, since the information processing method can estimate the shape of the target object 600 on the basis of the contact positions and postures of the thumb 121 and the index finger 122, it is not necessary to use a non-contact sensor or the like, and the cost of the hand 120 can be suppressed. Furthermore, the information processing method can suppress the influence of the property of the target object, for example, transparency, opacity, and the like, by estimating the shape of the target object 600 on the basis of the contact positions and postures of the thumb 121 and the index finger 122.

The information processing program causes a computer to execute: operating at least one of the thumb 121 and the index finger 122 to change contact positions with the target object 600 in a state where the thumb 121 and the index finger 122 grip the target object 600; and estimating the shape of the target object 600 on the basis of the relationship between the contact positions and postures of the thumb 121 and the index finger 122.

As a result, the information processing program can cause the computer to estimate the shape of the target object 600 by causing the thumb 121 and the index finger 122 to operate so as to change the contact position of at least one of the thumb 121 and the index finger 122 that grip the target object 600. As a result, the information processing method can easily estimate the shape of the gripped target object 600, so that the target object 600 having various shapes can be gripped. Furthermore, since the information processing method can estimate the shape of the target object 600 on the basis of the contact positions and postures of the thumb 121 and the index finger 122, it is not necessary to use a non-contact sensor or the like, and the cost of the hand 120 can be suppressed. Furthermore, the information processing method can suppress the influence of the property of the target object, for example, transparency, opacity, and the like, by estimating the shape of the target object 600 on the basis of the contact positions and postures of the thumb 121 and the index finger 122.

Note that the following configuration also belong to the technical scope of the present disclosure.

(1)

An information processing apparatus, including:
an operation control unit that operates at least one of a first finger and a second finger to change contact positions with a target object in a state where the first finger and the second finger grip the target object; and
an estimation unit that estimates a shape of the target object on a basis of a relationship between the contact positions and postures of the first finger and the second finger.
   (2)

The information processing apparatus according to (1), wherein
the second finger has a flat portion provided in a portion facing the first finger that grips the target object, and
the operation control unit moves the second finger so that the posture of the second finger changes in a state where the first finger maintains a state of being in contact with the target object and the flat portion of the second finger is in contact with the target object.
   (3)

The information processing apparatus according to (2), wherein the estimation unit estimates a shape of the target object on a basis of a change in the contact position with the target object in the flat portion of the second finger and the posture of the second finger.

(4)

The information processing apparatus according to (2) or (3),
the flat portion is provided with a pressure sensor capable of detecting a pressure distribution, and
the estimation unit estimates a shape of the target object on a basis of a relationship between the contact position and the posture based on the pressure distribution.
   (5)

The information processing apparatus according to any one of (1) to (4), wherein the operation control unit operates the second finger so that the contact position with the target object and the posture of the second finger change with a contact position of the second finger when the target object is gripped as a starting point.

(6)

The information processing apparatus according to any one of (1) to (5), wherein when the first finger and the second finger grip the target object, the operation control unit operates at least one of the first finger and the second finger so as to change a contact position with the target object before lifting the target object.

(7)

The information processing apparatus according to any one of (1) to (6), wherein the operation control unit operates the second finger so that a reaction force is generated at the contact position of the flat portion even if the contact position with the target object and the posture of the second finger are changed.

(8)

The information processing apparatus according to (5), wherein the operation control unit changes the posture of the second finger in a first direction from the starting point, and changes the posture of the second finger in a second direction different from the first direction when the pressure distribution between the second finger and the target object satisfies a switching condition.

(9)

The information processing apparatus according to (8), wherein the operation control unit changes the posture of the second finger in the second direction, and ends the change in the posture of the second finger when the pressure distribution between the second finger and the target object satisfies an end condition.

(10)

The information processing apparatus according to any one of (1) to (4), further including a determination unit that determines gripping positions of the first finger and the second finger on a basis of the shape of the target object estimated by the estimation unit, wherein
the operation control unit controls operations of the first finger and the second finger so as to grip at the gripping positions.
   (11)
The information processing apparatus according to any one of (1) to (10), wherein the operation control unit operates a hand provided with the first finger and the second finger so as to lift the target object when the first finger and the second finger grip the target object at the gripping positions.
   (12)

An information processing method including:
operating, by a computer, at least one of a first finger and a second finger to change contact positions with a target object in a state where the first finger and the second finger grip the target object; and
estimating, by the computer, a shape of the target object on a basis of a relationship between the contact positions and postures of the first finger and the second finger.
   (13)

An information processing program causing a computer to execute:
operating at least one of a first finger and a second finger to change contact positions with a target object in a state where the first finger and the second finger grip the target object; and
estimating a shape of the target object on a basis of a relationship between the contact positions and postures of the first finger and the second finger.
   (14)

A robot including:
an arm including a first finger and a second finger;
a drive unit that moves the first finger and the second finger; and
an information processing apparatus that controls the drive unit, in which
the information processing apparatus includes:
an operation control unit that operates at least one of the first finger and the second finger under control of the drive unit such that contact positions with a target object changes in a state where the first finger and the second finger grip the target object; and
an estimation unit that estimates a shape of the target object on the basis of a relationship between the contact positions and postures of the first finger and the second finger.

### REFERENCE SIGNS LIST

10 SENSOR UNIT
11 IMAGING UNIT
12 STATE SENSOR
13 PRESSURE SENSOR
20 DRIVE UNIT
30 INFORMATION PROCESSING APPARATUS
31 STORAGE UNIT
32 CONTROL UNIT
40 COMMUNICATION UNIT
100 ROBOT
120 HAND
121 THUMB (FIRST FINGER)
122 INDEX FINGER (SECOND FINGER)
311 PRESSURE INFORMATION
312 POSTURE INFORMATION
321 OPERATION CONTROL UNIT
322 ESTIMATION UNIT
323 DETERMINATION UNIT
324 RECOGNITION UNIT

1. An information processing apparatus, including:
an operation control unit that operates at least one of a first finger and a second finger to change contact positions with a target object in a state where the first finger and the second finger grip the target object; and
an estimation unit that estimates a shape of the target object on a basis of a relationship between the contact positions and postures of the first finger and the second finger.

2. The information processing apparatus according to claim 1, wherein
the second finger has a flat portion provided in a portion facing the first finger that grips the target object, and
the operation control unit moves the second finger so that the posture of the second finger changes in a state where the first finger maintains a state of being in contact with the target object and the flat portion of the second finger is in contact with the target object.

3. The information processing apparatus according to claim 2, wherein the estimation unit estimates a shape of the target object on a basis of a change in the contact position with the target object in the flat portion of the second finger and the posture of the second finger.

4. The information processing apparatus according to claim 3, wherein the operation control unit operates the second finger so that the contact position with the target object and the posture of the second finger change with a contact position of the second finger when the target object is gripped as a starting point.

5. The information processing apparatus according to claim 4, wherein when the first finger and the second finger grip the target object, the operation control unit operates at least one of the first finger and the second finger so as to change a contact position with the target object before lifting the target object.

6. The information processing apparatus according to claim 5, wherein
the flat portion is provided with a pressure sensor capable of detecting a pressure distribution, and
the estimation unit estimates a shape of the target object on a basis of a relationship between the contact position and the posture based on the pressure distribution.

7. The information processing apparatus according to claim 6, wherein the operation control unit operates the second finger so that a reaction force is generated at the contact position of the flat portion even if the contact position with the target object and the posture of the second finger are changed.

8. The information processing apparatus according to claim 4, wherein the operation control unit changes the posture of the second finger in a first direction from the starting point, and changes the posture of the second finger in a second direction different from the first direction when the pressure distribution between the second finger and the target object satisfies a switching condition.

9. The information processing apparatus according to claim 8, wherein the operation control unit changes the posture of the second finger in the second direction, and ends the change in the posture of the second finger when the pressure distribution between the second finger and the target object satisfies an end condition.

10. The information processing apparatus according to claim 4, further including a determination unit that determines gripping positions of the first finger and the second finger on a basis of the shape of the target object estimated by the estimation unit, wherein
the operation control unit controls operations of the first finger and the second finger so as to grip at the gripping positions.

11. The information processing apparatus according to claim 10, wherein the operation control unit operates a hand provided with the first finger and the second finger so as to lift the target object when the first finger and the second finger grip the target object at the gripping positions.

12. An information processing method including:
operating, by a computer, at least one of a first finger and a second finger to change contact positions with a target object in a state where the first finger and the second finger grip the target object; and
estimating, by the computer, a shape of the target object on a basis of a relationship between the contact positions and postures of the first finger and the second finger.

13. An information processing program causing a computer to execute:
operating at least one of a first finger and a second finger to change contact positions with a target object in a state where the first finger and the second finger grip the target object; and
estimating a shape of the target object on a basis of a relationship between the contact positions and postures of the first finger and the second finger.
